(19) United States
(12) Patent Application Publication
(10) Pub. No.: US 2009/0133959 A1
(43) Pub. Date: May 28, 2009

(54) Collapsible Platform

(75) Inventor: Per-Olof Eriksson, Tranas (SE)

Correspondence Address: BREINER & BREINER, L.L.C., P.O. BOX 320160, ALEXANDRIA, VA, 22320-0160, US

(73) Assignee: Telesteps AB, Tranas (SE)

(21) Appl. No.: 12/084,850

(22) PCT Filed: Oct. 24, 2006
(86) PCT No.: PCT/EP2006/067700

§ 371 Date: Jul. 24, 2008

(30) Foreign Application Priority Data
Nov. 18, 2005 (EP) 05025195.8

(51) Int. Cl. E04G 1/24; E04G 1/22; E04G 7/00; E06C 7/16; E04G 1/34

(52) U.S. Cl. 182/118

(57) ABSTRACT

A collapsible working platform including a working platform and a first and a second telescopically collapsible ladder leg, where the first and second legs are hingedly connected to one end of the working platform, each to a separate end of the working platform. Each of the first and second legs includes several ladder sections. Each ladder section is telescopically inserted into a lower ladder section to form a collapsible ladder including at least two ladder sections. The working platform includes two platform parts. The platform parts are hingedly connected to each other at one end and connected to a respective ladder leg at the other end. The two platform parts are foldable so that the platform parts are arranged in parallel when placed in a folded position.

### FIELD OF THE INVENTION

The present invention relates to a collapsible working platform provided with ladder sections being telescopically inserted in each other.

### BACKGROUND OF THE INVENTION

Collapsible and expandable working Collapsible are known in the art. Examples of prior art Collapsible Collapsible are described below.

In EP-A1-0 952 277 a telescopically collapsible platform is disclosed comprising a work surface and two telescopic collapsible legs. The legs are pivoted so as to be folded down inside a small box. The bottom and sidewalls of the box constitute the work surface and the lateral reinforcements of this work surface.

In U.S. Pat. No. 3,722,621 a ladder bench, including a horizontal telescopically arranged bench surface and two foldable support legs, is disclosed. The foldable support legs are pivotally hinged at each end of the bench surface.

The problem with the above prior art is that the folding mechanisms are complicated and that the arrangement is clumsy in the folded mode, and thereby complicated to fold and unfold and difficult to transport.

The object of the present invention is to overcome the shortcomings of the prior art and to provide a collapsible working platform that is compact when collapsed, that is easy to erect and that is sturdy when assembled.

### SUMMARY OF THE INVENTION

A collapsible working platform according to the characterizing features of claim 1 solves the above problem.

The features of the dependent claims define further aspects and preferred embodiments of the claimed invention.

### BRIEF DESCRIPTION OF THE DRAWINGS

In the following, the invention will be explained with reference to the accompanying drawings, wherein:

FIG. 1 is a perspective view of an unfolded collapsible working platform according to the invention;

FIG. 2 is a side view of the collapsible working platform according to the invention, where all ladder sections are fully extended;

FIG. 3 is a side view of the collapsible working platform according to the invention, where both ladder legs are partially folded;

FIG. 4 is a side view of the collapsible working platform according to the invention, where one ladder leg is fully extended and another ladder leg is partially extended;

FIG. 5 is a side view of the collapsible working platform according to the invention, where all ladder sections are completely folded;

FIG. 6 is a side view of the collapsible working platform according to the invention, where all ladder sections are completely folded and where the ladder legs are pivoted towards the underside of the platform;

FIG. 7 is a side view of the collapsible working platform according to the invention, where all ladder sections are completely folded and where the ladder legs are pivoted towards the underside of the platform and where the platform is folded;

FIGS. 8a-b are perspective views of the completely folded collapsible working platform according to the invention, where alternative carrying means are shown;

FIG. 9 is partial detail view of a first hinge connection arranged on the collapsible working platform according to the invention; and

FIG. 10 is partial detail view of a second hinge connection arranged on the collapsible working platform according to the invention.

### DETAILED DESCRIPTION OF THE EMBODIMENTS

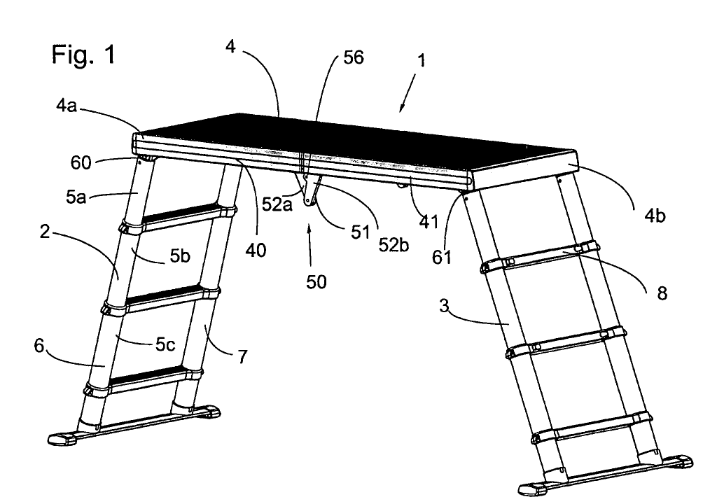

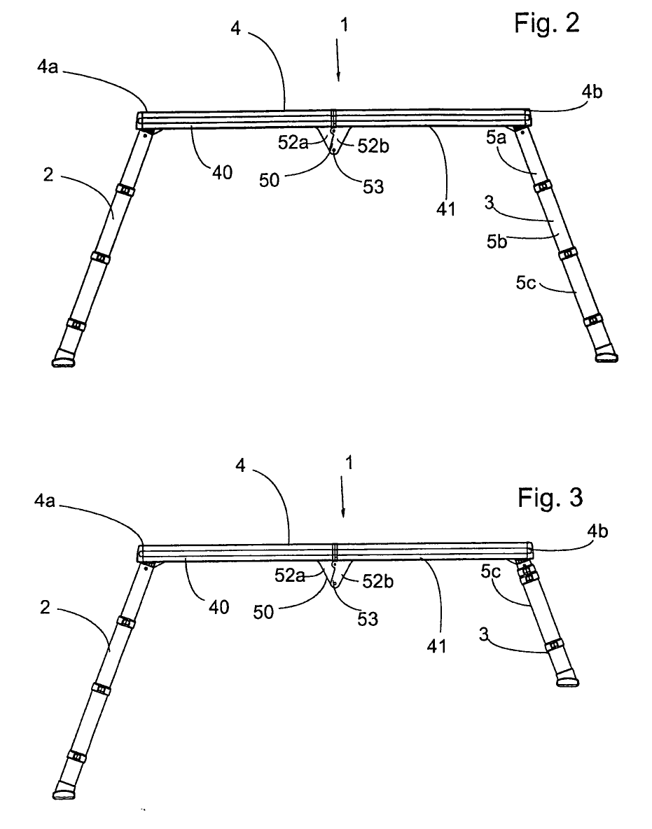

A collapsible working platform 1 according to the invention is shown in the drawings. FIG. 1 shows a collapsible working platform 1 comprising a working platform 4, a first and a second ladder leg 2 and 3, respectively. The ladder legs 2, 3 are hingedly connected in one end to the working platform 4, the first ladder leg 2 is hingedly connected to a first end 4a of the working platform 4 and the second ladder leg 3 is connected to a second end 4b of the working platform 4. Each of the ladder legs 2, 3 comprises several ladder sections 5a-5c, and where each section 5a-5b comprises two ladder bars 6, 7 arranged parallel to each other and interconnected at one end by a rung 8 to form a U-shaped ladder section. Furthermore each ladder section 5a-5b is telescopically inserted into a lower ladder section to form a collapsible ladder leg 2, 3 comprising at least two ladder sections 5a, 5b. The number of ladder sections is limited by the stability of the working platform 1 and the requirement to pass type approval.

The working platform 4 comprises two platform parts 40, 41, the platform parts 40, 41 being hingedly connected to each other in an end 4c and connected to the ladder legs in the other end 4a and 4b, respectively, and where two platform parts 40, 41 are foldable so that the platform parts 40, 41 are parallelly arranged in the folded position.

Each rung 8 of the two ladder legs 2, 3 comprises a retaining mechanism for automatically locking the ladder sections relative to one another when the ladder legs 2,3 are extended. The retaining mechanism could be any kind previously known in the art, e.g. any of the retaining mechanisms shown in EP-B1-0 527 766 or EP-B1-1 402 143.

If the retaining mechanism of EP-B1-0 527 766 is used each of the ladder legs 2,3 will only have two modes, completely collapsed or extended, due to the functionality of the retaining mechanism. This retaining mechanism, which forms a part of a release mechanisms of the ladder legs 2, 3, comprises pins biased by springs towards holes or recesses in the ladder bar of the ladder section and releases levers for retracting the pins from the ladder bar when each rung is collapsed onto the rung beneath it located in the rungs for automatically locking the ladder sections of the ladder bar relative to one another when the sections are extended, and where the retaining mechanisms in each rung are arranged to release the sections of the ladder bar connected to the next higher rung when the rung is collapsed against the next lower rung.

If the retaining mechanism of EP-B1-1 402 143 is used each of the ladder legs 2,3 will have three modes, completely collapsed, extended by one ladder section and completely extended. This retaining mechanism, which is a part of the release mechanisms of the ladder legs 2, 3, comprises a locking pin being spring biased towards an extended position in order to engage a locking hole provided in the ladder bar of a ladder section positioned thereabove and an actuator for moving the locking pin into a retracted position and where the actuator is arranged to be actuated outside of the space between the rungs and is designed to be released manually and individually at both sides of a ladder section.

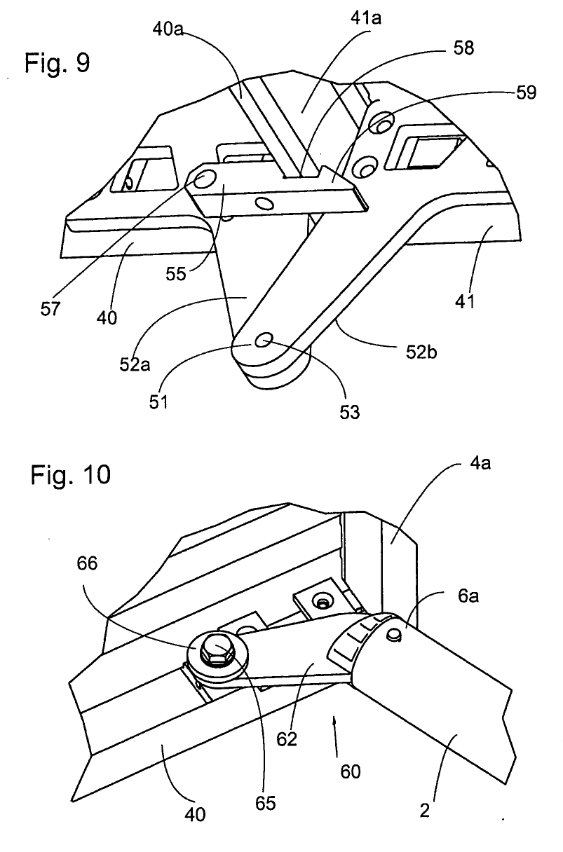

As stated above the platform 4 comprises two platform parts 40, 41 and the two parts are hingedly connected to each other. The hinge 50 connecting the platform parts 40, 41 is formed as two hinges 51 arranged on the underside of the platform 4, whereby one hinge 51 is arranged at each end 45 of the connection between the two platform parts 40, 41. The hinge 51 comprises two brackets 52a, 52b provided with a hole 53, whereby one bracket 52a is arranged on platform part 40, and one bracket is arranged 52b on platform part 41, and an axis 54 of the hinge is received in the hole 53 that connects the brackets 52a, 52b. The axis 54 can extend through the holes of a first hinge 51a, but can also extend over the space between the hinges 51a-b and through the second hinge 51b. The bracket 52a is provided with a hook 55, which is pivotally arranged on a pin 57 on the bracket 52a. The hook 55, which is biased, is provided with a recess 58 and end portion 59. In the recess 58 end portions 40a and 41a of the platform parts 40 and 41, respectively, are received, when the platform parts 40 and 41 are unfold to form the platform 4. When the end portions 40a and 41a of the platform parts 40 and 41 are received in the recess 58, the hook 55 prevents the platform parts 40, 41 from being folded in relation to each other if the working platform 1 is lifted or in any other way handled so that the hinge 50 is affected. The end portion 59 is used to unlock the hook 55 by moving the end portion 59 downwards (as seen in FIG. 9) so that the end portions 40a and 41a no longer are kept together by the recess 58.

Alternatively, the brackets 52a, 52b can be provided with a biased locking pin (not shown) that can be actuated into a hole 56 (see FIG. 1) of the brackets 52a, 52b to lock the brackets 52a-b in relation to each other and thereby preventing the platform parts 40, 41 from being folded in relation to each other if the working platform 1 handled. Any other locking mechanism can also be used that locks the brackets 52a and 52b in relation to each other and that secures that the platform parts 40 and 41 cannot be folded if the working platform 1 is lifted or in any other way handled so that the hinge 50 is affected.

Between the ladder legs 2, 3 and the platform 4 hinge connections 60, 61 are arranged, where the hinge connection 60 is arranged between the ladder leg 2 and the platform part 40 and the hinge connection 61 is arranged between the ladder leg 3 and the platform part 41. The hinge connections 60 and 61 are identical, and therefore only the hinge connection 60 will be described.

In FIG. 10 one part of the hinge connection 60, which is formed as a connection arranged between the platform part 40 and the ladder leg 2 is shown. The hinge connection 60 comprises a bracket 62 arranged at each end 6a of the ladder bars 6 and 7 of the ladder leg 2, a mounting bolt or mounting pin 63 (not shown) arranged on the platform part 40 and a friction washer set 66. The end of the bracket 62 not being attached to the end 6a is provided with a hole 65, where the mounting bolt 63 can be received to attach the bracket 62 and thereby also the ladder leg 2 to platform part 40. The set of friction washers 66 is arranged on the mounting bolt 63, surrounding the bracket 63 to create the friction guiding of the bracket 62 relative to the platform part 40. A nut 65 arranged on the mounting bolt 63 ensures that the bracket 62 and the friction washer set 66 are squeezed together.

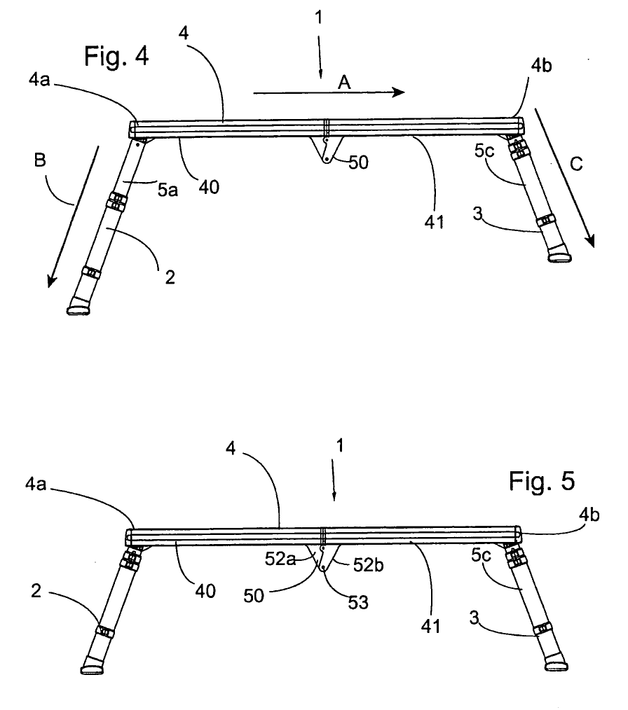

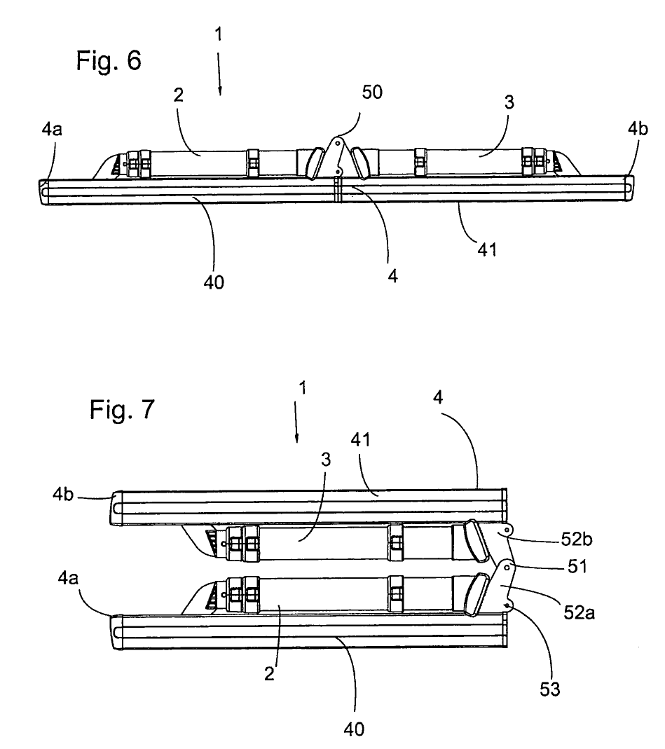

The friction washer set 66 serves to keep the ladder leg 2 in its position relative to the platform part 40 if the working platform 1 is lifted in order to be moved to another place of use. The friction washer 66 may provide that the hinges 60 have two end positions, a first position when the ladder leg 2 is being pivoted out in relation to a longitudinal direction A of the platform 4 (see FIG. 4), the operation position, and being obliquely arranged in relation to the longitudinal direction A of the platform 4, and a second position when the ladder leg 2 is being pivoted to a storage position and being substantially parallely arranged in relation to the longitudinal direction A of the platform 4. Between the end positions the friction washer 66 serves to reduce the speed of pivoting the ladder leg 2 in relation to the platform 4 and reduce the risk of injury caused by crushing.

The friction washer 66 may be replaced by any other known technical solution that fulfills the same purpose and characteristics as the friction washer, such locking pins, hooks or the like.

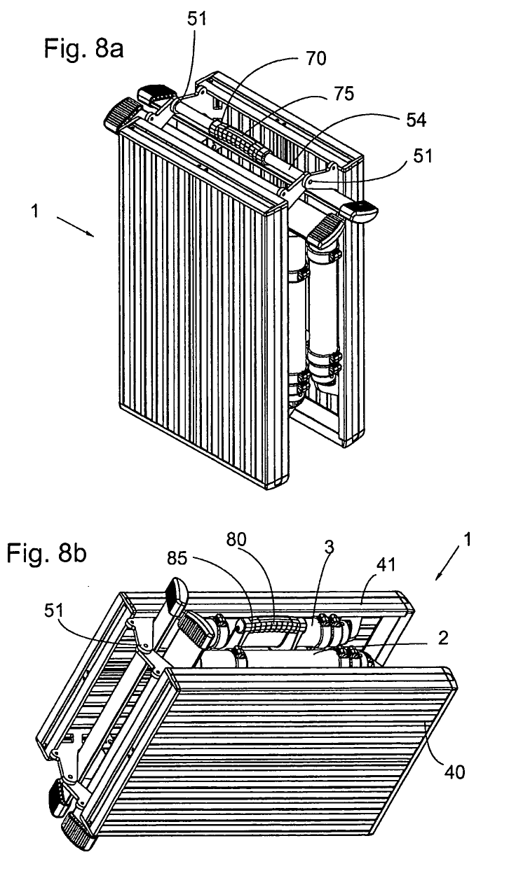

In FIGS. 8a-8b alternative arrangements 70, 80 for carrying the collapsible working platform 1 are shown. In FIG. 8a the axis of the hinges 51 or the extension of the axis of the hinges 51 is used as carrying handle 70. The carrying handle 70 has been provided with a grip 75 surrounding the axis of the hinges 51 and extended along a portion of the same. The grip, which is made of a rubber material or the like, makes it more comfortable to carry the folded collapsible working platform 1.

In FIG. 8b the carrying handle 80 is flexibly and removably attached to one of each of the ladder bars 6, 7 of the ladder legs 2, 3. The carrying handle 80, which partially surrounds the ladder bars 6, 7, is squeezed into position. Similar to the carrying handle 70, the carrying handle 80 is provided with a grip 85, which is made of a rubber material or the like, and makes it more comfortable to carry the folded collapsible working platform 1.

Now the function or handling of the collapsible working platform 1 is going to be described. The working platform 1 is from the start folded as in FIG. 8a or 8b. In the case of the arrangement of FIG. 8b, the carrying handle 80, which also serves as a means for holding the working platform together in the folded mode, is removed. The platform parts 40, 41 are unfolded or pivoted in relation to each other around the hinge connection 51 until the adjacent end parts of the platform parts 40, 41 are facing each other and the two platform parts 40, 41 together form a platform 4 having a longitudinal direction A. The platform parts 40, 41 are locked in relation to each other by the hook 55 so that the platform parts 40, 41 will not be pivoted in relation to each other when the working platform 1 is in use.

The ladder legs 2, 3 are unfolded by being pivoted around the hinges 60, 61 in relation to the platform parts 40, 41 so that the longitudinal direction B and C, respectively, of the ladder legs 2, 3 (see FIG. 4) is oblique in relation to the longitudinal direction A of the platform 4, with an angle a of about 105 degrees between the longitudinal direction B and C, respectively, of the ladder legs 2, 3 and the longitudinal direction A of the platform 4. The friction washers 66 ensure that the ladder legs 2, 3 are kept in place after the ladder legs 2, 3 have been pivoted to the unfolded mode.

After that the working platform 1 is lifted and turned around so that the ladder legs 2, 3 are placed on the ground and the working platform 1 is ready for use. If the user needs an elevation of the working platform 1 due to the work that is to be carried out, the ladder legs 2, 3 can be extended so that the needed height of the working platform 1 is achieved. If the ground, where the working platform 1 is placed, is uneven the ladder legs 2, 3 can be extended differently to compensate for the uneven ground, see e.g. FIG. 3. Also, if the working platform is moved the ladder legs can be adjusted to the working place and conditions.

The process of folding the working platform 1 is performed by reversing of the unfolding process described above.

In the shown embodiments the working platform 1 or the legs 2 and 3 of the working platform 1 comprise three ladder sections 5a-5c, but there could of course the fewer or more collapsible ladder sections, like 2, 4 or 5 ladder sections.

The invention is not limited to the embodiments described above and shown in the drawings, but can be supplemented and modified in any manner within the scope of the invention as defined by the appended claims.

1. A collapsible working platform comprising a working platform and a first telescopically collapsible ladder leg and a second telescopically collapsible ladder leg, where the first leg and the second leg are hingedly connected by a hinge connection to one end of the working platform, each at a different end of the working platform, and where each of the first leg and the second leg comprises a plurality of ladder sections, and where each ladder section of said ladder sections comprises two ladder bars arranged parallel to each other and interconnected at one end by a rung to form a U-shaped ladder section, whereby furthermore each ladder section is telescopically inserted into a lower ladder section to form a collapsible ladder part comprising at least two ladder sections, wherein the working platform comprises two platform parts, the two platform parts being hingedly connected to each other at one end thereof and connected to the first leg at an opposite end, respectively, and where the two platform parts are foldable so that the two platform parts are arranged in parallel when in a folded position.

2. The collapsible working platform according to claim 1, wherein the first leg and the second leg are each foldable and storable in a folded mode within one of the two platform parts, respectively.

3. The collapsible working platform according to claim 1, wherein the two platform parts in an unfolded mode are provided with means to prevent unintentional folding of the working platform when in the unfolded mode.

4. The collapsible working platform according to claim 3, wherein the means to prevent unintentional folding of the two platform parts of the working platform in the unfolded mode, is a hook that locks the two platform parts in relation to each other.

5. The collapsible working platform according to claim 1, wherein the hinge connection between the first leg and the second leg and the two platform parts comprises means to prevent unintentional folding of the first leg and the second leg in an unfolded mode.

6. The collapsible working platform according to claim 5, wherein the hinge connection between the first leg and the second leg and the two platform parts comprises a friction washer set structured to prevent unintentional folding of the first leg and the second leg in the unfolded mode.

7. The collapsible working platform according to claim 1, wherein release mechanisms are arranged on the first leg and on the second leg.

8. The collapsible working platform according to claim 7, wherein the first leg and the second leg are provided with release mechanisms arranged on a front side of rungs.

9. The collapsible working platform according to claim 8, wherein the release mechanisms are a retaining mechanism comprising a locking pin which is spring biased towards an extended position to engage a locking hole provided in a ladder bar of the ladder section positioned thereabove and an actuator for moving a locking pin into a retracted position, the actuator being arranged to be actuated outside of a space between rungs and is structured to be released manually and individually at both sides of a respective ladder section.

10. The collapsible working platform according to claim 7, wherein the first leg and the second leg are provided with release mechanisms arranged on an underside of a second lowermost rung.

11. The collapsible working platform according to claim 10, wherein the release mechanisms of the first leg and the second leg are a retaining mechanism comprising pins biased by springs towards holes or recesses in a ladder bar of the ladder section and release levers for retracting the pins from the ladder bar when each rung is collapsed onto a below-located rung located in the rungs for automatically locking the ladder sections of the ladder bar relative to one another when the sections are extended, and where the retaining mechanisms in each rung are arranged to release the sections of the ladder bar connected to a next higher rung when the rung is collapsed against the a next lower rung.

12. The collapsible working platform according to claim 1, wherein the working platform includes a handle to carry the working platform in a folded mode.

13. The collapsible working platform according to claim 12, wherein the handle is attached to a bar extending between two hinge connections present between the two platform parts.

14. The collapsible working platform according to claim 12, wherein the handle is releasably attached to the first leg and the second leg.

15. The collapsible working platform according to claim 1, wherein the collapsible working platform is adjustable to three different height modes as to each of the first leg and the second leg.

16. The collapsible working platform according to claim 2, wherein the two platform parts in an unfolded mode are provided with means to prevent unintentional folding of the working platform when in the unfolded mode.

17. The collapsible working platform according to claim 16, wherein the means to prevent unintentional folding of the two platform parts of the working platform in the unfolded mode, is a hook that locks the two platform parts in relation to each other.
